(19) United States
(12) Patent Application Publication
(10) Pub. No.: US 2024/0302513 A1
(43) Pub. Date: Sep. 12, 2024

(54) RADIO WAVE INFORMATION MANAGEMENT SYSTEM, RADIO WAVE INFORMATION MANAGEMENT METHOD AND STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Tatsuma HIRANO, Kawasaki Kanagawa (JP); Daisuke UCHIDA, Kawasaki Kanagawa (JP); Satoshi TAKAYA, Kawasaki Kanagawa (JP); Tomoya TANDAI, Ota Tokyo (JP); Hiroyuki NISHIKAWA, Iruma Saitama (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/669,830

(22) Filed: May 21, 2024

Related U.S. Application Data
(63) Continuation of application No. PCT/JP2023/009790, filed on Mar. 14, 2023.

(30) Foreign Application Priority Data
Apr. 27, 2022 (JP) 2022-073224

(51) Int. Cl. G01S 11/02; H04W 64/00

(52) U.S. Cl. CPC G01S 11/026; H04W 64/006

(57) ABSTRACT

According to one embodiment, a radio wave information management system includes an information stored unit, a radio wave information determination unit, and a route setting unit. The information stored unit stores radio wave information, and location information and time information associated with the radio wave information. The radio wave information determination unit sets reliability information for the radio wave information based on at least one of the location information and the time information. The route setting unit sets a route of a mobile object based on the reliability information.

### CROSS-REFERENCE TO RELATED APPLICATIONS

This application is a Continuation application of PCT Application No. PCT/JP2023/009790, filed Mar. 14, 2023 and based upon and claims the benefit of priority from Japanese Patent Application No. 2022-073224, filed Apr. 27, 2022, the entire contents of all of which are incorporated herein by reference.

### FIELD

Embodiments described herein relate generally to a radio wave information management system, a radio wave information management method and a storage medium.

### BACKGROUND

As a technology for estimating the intensity of radio waves of wireless signals, for example, wireless signal reception state evaluation devices are suggested. The wireless signal reception state evaluation devices measure the reception intensity of a radio wave at the same spot a plurality of times, deal with the reception intensities which are measured a plurality of times as statistical information, and determine whether the wireless signals are transmitted by multipath or indicate constant values. In addition, for example, area evaluation display devices which display the range of the reception intensity for a location in consideration of the effect of shadowing based on a confidence interval and a standard deviation are suggested. Further, for example, received power estimation devices which estimate the received power in consideration of the structure and room layout of buildings are suggested.

In the technologies described above, the intensity of radio waves is estimated in consideration of the measured reception intensity of the radio waves and the environment. However, the technologies cannot estimate the reception intensity of radio waves based on the data measured by a plurality of wireless devices or cannot respond to the change in environment over time.

### BRIEF DESCRIPTION OF THE DRAWINGS

FIG. 1 is a block diagram of a radio wave information management device according to a first embodiment.

FIG. 2 is a diagram showing an example of a system to which the radio wave information management device of the first embodiment is applied.

FIG. 3 is a block diagram of an operation management system to which the radio wave information management device of the first embodiment is applied.

FIG. 4 is a diagram for explaining a method of determining the reception intensity information of radio waves by a radio wave information determination unit in a radio wave information management device according to a second embodiment.

FIG. 5 is a flowchart showing the operation procedure of the radio wave information determination unit in the radio wave information management device according to the second embodiment.

FIG. 6 is a diagram for explaining a method of determining the reception intensity information of radio waves by a radio wave information determination unit in a radio wave information management device according to a third embodiment.

FIG. 7 is a flowchart showing the operation procedure of the radio wave information determination unit in the radio wave information management device according to the third embodiment.

### DETAILED DESCRIPTION

In general, according to one embodiment, a radio wave information management system includes an information stored unit, a radio wave information determination unit, and a route setting unit. The information stored unit stores radio wave information, and location information and time information associated with the radio wave information. The radio wave information determination unit sets reliability information for the radio wave information based on at least one of the location information and the time information. The route setting unit sets a route of a mobile object based on the reliability information.

Embodiments will be described hereinafter with reference to the accompanying drawings.

### First Embodiment

A first embodiment is explained.

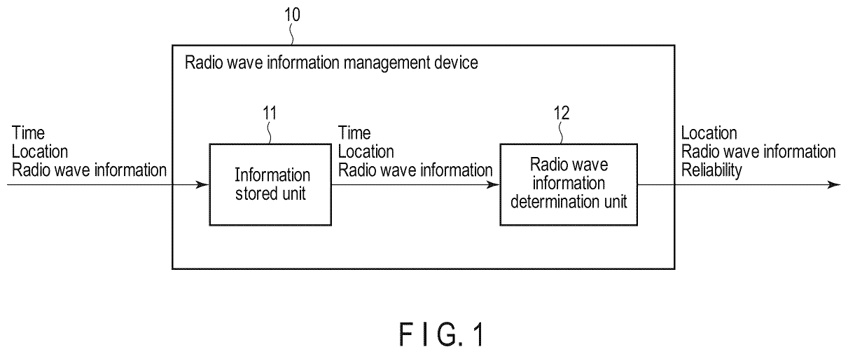

FIG. 1 is a block diagram of a radio wave information management device 10 according to the first embodiment. The radio wave information management device 10 comprises an information stored unit 11 and a radio wave information determination unit 12. The radio wave information management device 10 may be, for example, mounted on a mobile object such as an autonomous mobile robot (AMR) or constructed on a server device (not shown) which controls a mobile object.

For example, the information stored unit 11 stores the reception intensity of a radio wave (radio wave information) from a base station measured by a mobile object on which a wireless device is mounted with the time and location at which the reception intensity is measured. Various storage devices such as a hard disk drive (HDD) and a solid state drive (SSD) can be applied to the information stored unit 11. The radio wave information management device 10 comprises a reception unit (not shown) which receives the radio wave information, time and location to be held in the information stored unit 11 in a wireless or wired manner.

The radio wave information determination unit 12 determines the reception intensity of a radio wave at each spot (location) in a predetermined geographic range and its reliability based on the information held in the information stored unit 11. For example, the radio wave information determination unit 12 may be realized when a processor executes a program or may be realized as hardware such as an electronic circuit.

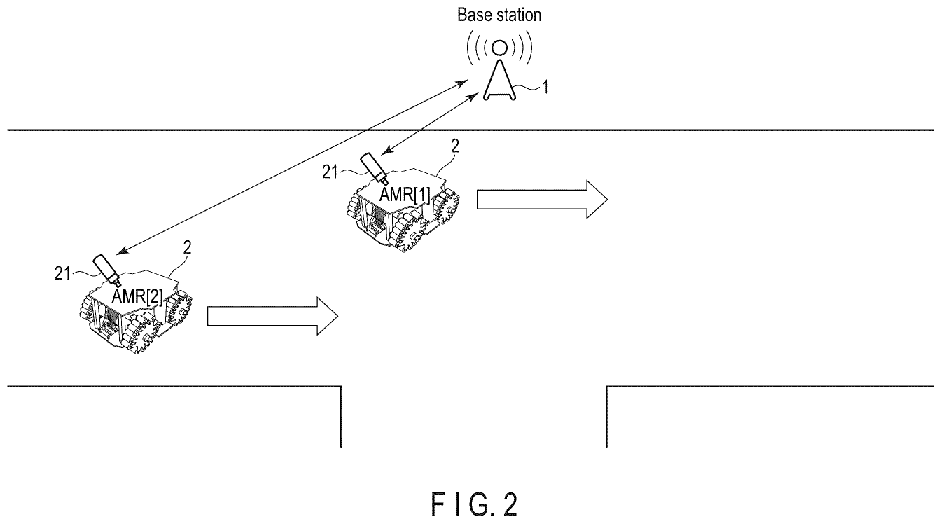

FIG. 2 is a diagram showing an example of a system to which the radio wave information management device 10 is applied. This system includes a base station 1, and two AMRs (AMR [1] and AMR [2]) 2 on which a wireless device 21 capable of receiving radio waves from the base station 1 is mounted.

This system receives radio waves from the base station 1 in the wireless devices 21 mounted on the AMRs 2 and measures the reception intensity. At this time, the system also obtains location information and time information. For example, the location information may be obtained by measurement using a global navigation satellite system (GNSS) or a tachogenerator. However, the method is not limited to these examples. As a method of obtaining the time information, for example, the time may be obtained from an operating system (OS) which operates on each AMR 2 after time synchronization is performed by the GNSS described above or a network time protocol (NTP). However, the method is not limited to these examples.

The radio wave information management device 10 holds the reception intensity (radio wave information) measured by each AMR 2 in association with the time information and location information obtained at the same time in the information stored unit 11 for each AMR 2. When the radio wave information management device 10 is provided outside the AMRs 2, for example, the information is wirelessly transmitted from the wireless device 21 mounted on each AMR 2 to the radio wave information management device 10. When the radio wave information management device 10 is provided outside the AMRs 2, for example, the radio wave information management device 10 is on a server device (not shown) which controls a mobile object (here, each AMR 2) as described above.

The radio wave information management device 10 determines the reception intensity of a radio wave at each spot (location) in a predetermined geographic range and its reliability in the radio wave information determination unit 12 based on the radio wave information obtained from the AMRs 2 and held in the information stored unit 11.

Here, in general, the reliability of the reception intensity of radio waves has the property of decreasing in accordance with the elapsed time from the acquisition of the radio waves. In the radio wave information management device 10 of the first embodiment, the radio wave information determination unit 12 decreases the reliability of the reception intensity of radio waves in accordance with the elapsed time from the acquisition of the radio waves.

When each AMR 2 runs several times to obtain the reception intensity of radio waves, the reception intensity of radio waves may be obtained at the same spot. In this case, the change over time is less in the reception intensity of radio waves in that place. Thus, the radio wave information determination unit 12 may make the degree of the decrease in reliability less.

Further, the radio wave information determination unit 12 may sort out radio wave information in accordance with the reliability. For example, when a plurality of AMRs 2 obtain the reception intensities of radio waves at the same spot, the radio wave information determination unit 12 may maintain only the reception intensity information having a high reliability.

Moreover, when the reception intensity of a spot at which the reception intensity is not measured is estimated or linearly or nonlinearly complemented based on the obtained reception intensity information of radio waves, the radio wave information determination unit 12 may differentiate the degree of the decrease in reliability. For example, the radio wave information determination unit 12 may make the degree of the decrease in the reliability of the reception intensity information of a spot based on measurement less than that of the reception intensity information of a spot based on estimation or complement.

Various methods are considered regarding the minimum unit of a spot for holding the reception intensity information of radio waves. For example, a value obtained from the movement speed of each AMR 2 and the interval of the acquisition of the reception intensity of radio waves or a value related to the wavelengths of the radio waves for obtaining the reception intensity may be taken in.

Thus, the radio wave information management device 10 of the first embodiment provides a reliability based on the time elapsed for the reception intensity information of radio waves. By this configuration, the system to which the radio wave information management device 10 is applied can deal with the reception intensity information of radio waves in accordance with the change in environment over time.

### Application Examples

In the above description, this specification explains a method of managing radio wave information by the radio wave information management device 10. The managed radio wave information may be used to, for example, manage the operation of each AMR 2. As an application example of the radio wave information management device 10, this specification explains a system to which the radio wave information management device 10 is applied and which is an operation management system for each AMR 2 based on radio wave information in which the reliability is managed as described above.

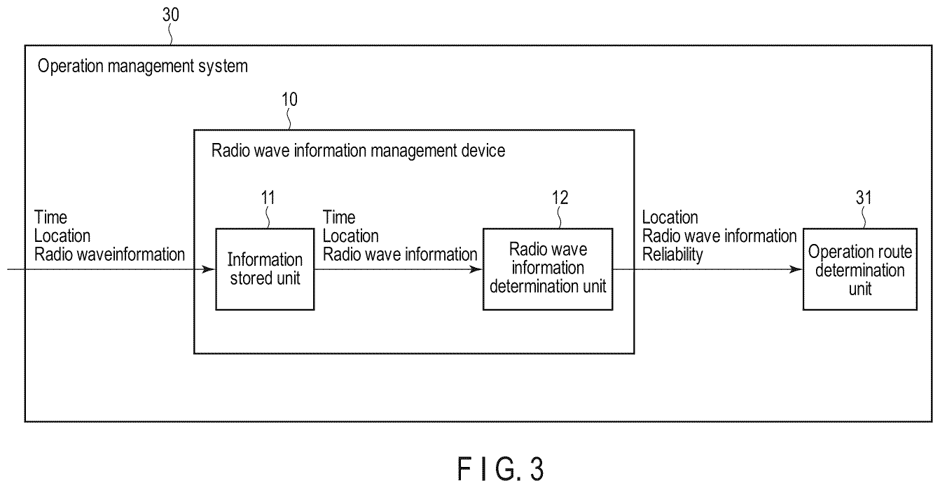

FIG. 3 is a block diagram of an operation management system 30 to which the radio wave information management device 10 is applied.

The operation management system 30 comprises an operation route determination unit 31. In the operation management system 30, the operation route determination unit 31 determines the operation route of each AMR 2 based on the information from the radio wave information determination unit 12 of the radio wave information management device 10. The operation route determination unit 31 may be realized when a processor executes a program or may be realized as hardware such as an electronic circuit.

The operation route determination unit 31 manages the operation of each AMR 2. For example, the operation route determination unit 31 preferentially sets portions from which the reception intensity of radio waves has not been obtained as the operation route of each AMR 2 and actively obtains the reception intensity information of radio waves. Thus, the operation route determination unit 31 may determine the operation route of each AMR 2 such that a plurality of AMRs 2 evenly pass through the spots from which the reception intensity of radio waves should be obtained by decreasing the overlapping portions in the operation routes of the AMRs 2 as much as possible. The operation route determination unit 31 receives radio wave information having a reliability from the radio wave information determination unit 12 as described above. Thus, the operation route determination unit 31 may preferentially determine a route including a spot with reception intensity information having a decreased reliability as the operation route of each AMR 2 to actively obtain the reception intensity information of radio waves.

In this way, the operation management system 30 to which the radio wave information management device 10 is applied can operate the AMRs 2 in association with the acquisition of the reception intensity information of radio waves by managing the operation of the AMRs 2 in accordance with the reliability of radio waves.

### Second Embodiment

Now, a second embodiment is explained.

In the first embodiment, this specification explains an example which enables the use of the reception intensity information of radio waves in accordance with the environmental change in environment over time by using a plurality of AMRs 2 and providing a reliability based on the time elapsed for the reception intensity information of radio waves. However, when a plurality of AMRs 2 obtain the reception intensity of radio waves, between an AMR 2 and a base station 1, another AMR 2 may be present. Thus, radio waves may be affected by the other AMR. When radio waves are affected, the reception intensity of the radio waves largely changes. Thus, the method of dealing with reception intensity information should be changed from that of a case where radio waves are not affected.

In the second embodiment, this specification explains a method of determining the reception intensity information of radio waves including reliability information when the radio waves are affected by AMR 2.

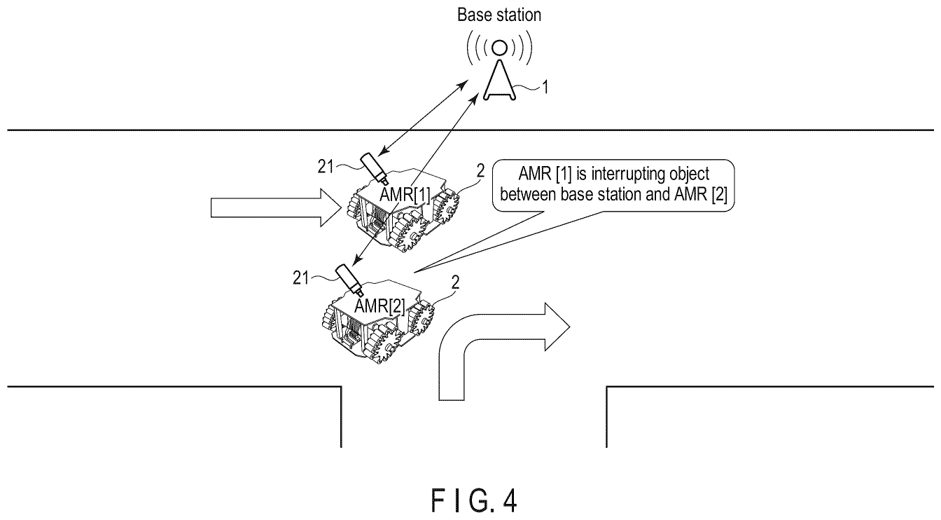

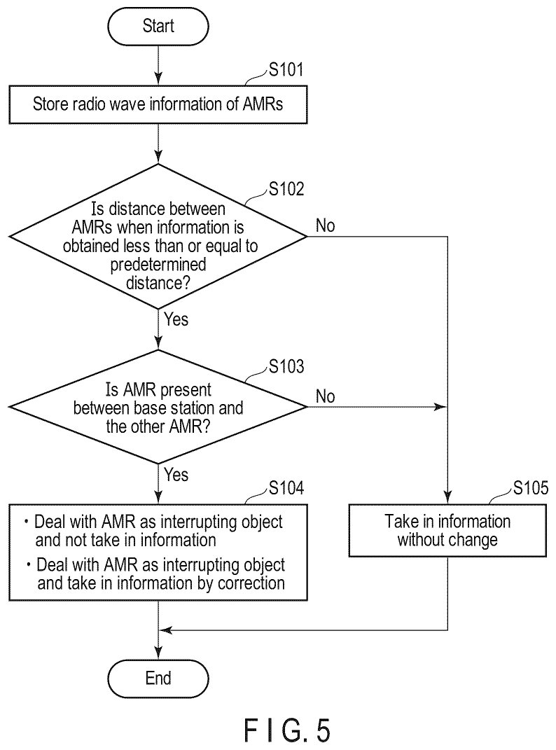

FIG. 4 shows a situation in which radio waves are affected by AMR 2 when AMR [1]2 is present between the base station 1 and AMR [2]2. Hereinafter, the operation of the radio wave information determination unit 12 of the second embodiment in such a situation is explained with reference to the flowchart of FIG. 5.

First, the radio wave information determination unit 12 stores the radio wave information of two AMRs 2 (S101). Subsequently, the radio wave information determination unit 12 obtains the distance between the two AMRs 2 from the time and location associated with the radio wave information (S102).

When the distance between the two AMRs 2 is greater than a predetermined distance (S102: No), the radio wave information determination unit 12 does not decrease the reliabilities of the radio wave information measured by the two AMRs 2 and takes in the reliabilities without change (S105). The predetermined distance may be, for example, a value related to the wavelengths of radio waves or may be a predetermined value. The predetermined distance is not limited to these examples. The value could be derived by various methods.

When the distance between the two AMRs 2 is less than or equal to the predetermined distance (S102: Yes), the radio wave information determination unit 12 determines whether or not one of the AMRs 2 is present between the base station 1 and the other AMR 2 (S103).

When one of the AMRs 2 is not present between the base station 1 and the other AMR 2 (S103: No), the radio wave information determination unit 12 does not decrease the reliabilities of the radio wave information measured by these two AMRs 2 and takes in the reliabilities without change (S105).

When one of the AMRs 2 is present between the base station 1 and the other AMR 2 (S103: Yes), the radio wave information determination 12 deals with the intervening AMR 2 as an interrupting object and does not take in the radio wave information of the AMR 2 which is not the interrupting object (S104). Alternatively, the radio wave information determination unit 12 may take in the radio wave information by decreasing the reliability. The radio wave information determination unit 12 may take in the radio wave information by making the degree of the decrease in reliability over time great without decreasing the reliability.

In this way, the radio wave information management device 10 of the second embodiment can determine the reliability of reception intensity information in consideration of the situation of affected radio waves such as the determination of the reliability of the reception intensity information of radio waves in accordance with the location relationships of the AMRs 2.

### Third Embodiment

Now, a third embodiment is explained.

In the second embodiment, this specification explains a method of determining radio wave information when a plurality of AMRs 2 measure the reception intensity of radio waves and an AMR 2 is present in the paths of radio waves as a cover. When a plurality of AMRs 2 run in a predetermined geographic range, one of the AMRs 2 may often follow another one of the AMRs 2. In such a case, a plurality of AMRs 2 may measure the reception intensity of radio waves at the same spot.

In the third embodiment, this specification explains a method of determining the reception intensity information of radio waves when a plurality of AMRs 2 obtain the reception intensity of radio waves at the same point.

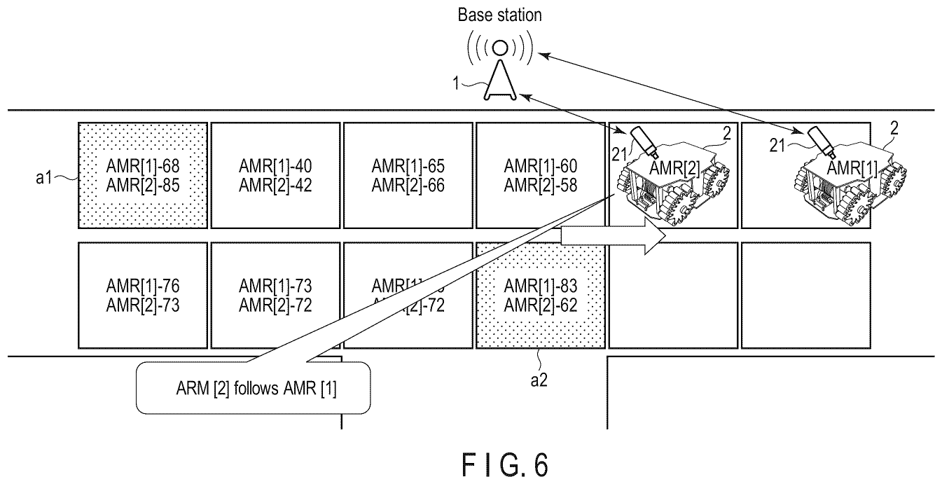

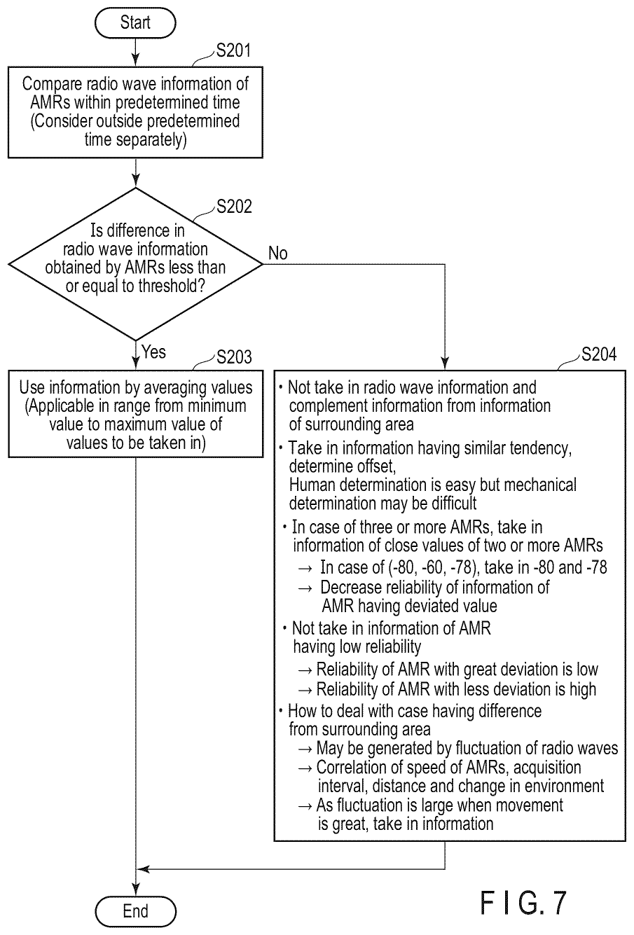

FIG. 6 shows a situation in which AMR [2]2 obtains the reception intensity of radio waves while following AMR [1]2. In FIG. 6, “nn” of “AMR [1]−nn” indicates the reception intensity of a radio wave obtained by AMR [1]2, and “nn” of “AMR [2]−nn” indicates the reception intensity of a radio wave obtained by AMR [2]2. In this example, the unit of the reception intensity of radio waves is dBm. However, the reception intensity information of radio waves may be held by using another unit. Each frame in which “AMR [1]−nn” and “AMR [2]−nn” are described indicates the minimum unit of a spot for holding the reception intensity information of radio waves. Of these frames, frames a1 and a2 with hatching show spots at which the two reception intensities of radio waves measured by the two AMRs 2 are largely different from each other. Hereinafter, the operation of the radio wave information determination unit 12 of the third embodiment in such a situation is explained with reference to the flowchart of FIG. 7.

First, the radio wave information determination unit 12 determines whether or not the reception intensity information of radio waves obtained by a plurality of AMRs 2 at the same spot includes information obtained within a predetermined time (S201). For example, the predetermined time may be determined in advance based on the movement speeds of the AMRs 2 and the resolution of the location of the reception intensity information of radio waves. The predetermined time is not limited to these examples and may be determined by various methods.

The radio wave information determination unit 12 determines whether or not the difference in a plurality of reception intensity information items of radio waves obtained within the predetermined time is less than or equal to a threshold (S202). For example, the threshold may be obtained from the statistical information of the reception intensities measured within a predetermined time, theoretical formulas based on the wavelengths of radio waves and the movement speeds of the AMRs 2, and the resolution of the location of the reception intensity information of radio waves. The threshold is not limited to these examples and may be obtained by various methods.

When the difference in the reception intensities of radio waves measured by a plurality of AMRs 2 at the same spot is less than or equal to the threshold (S202: Yes), the radio wave information determination unit 12 averages the information and takes in the averaged information, and does not decrease reliability information (S203). At this time, the radio wave information determination unit 12 may decrease the degree of the decrease in reliability information over time as the number of AMRs 2 by which the information is obtained at the same spot is increased.

When the difference in the reception intensities of radio waves measured by a plurality of AMRs 2 at the same spot is greater than the threshold (S202: Yes), the radio wave information determination unit 12 does not take in the radio wave information (S204). Alternatively, even when the radio wave information determination unit 12 takes in one of the reception intensities of the radio waves, the radio wave information determination unit 12 sets the reliability of the reception intensity so as to be low or sets the degree of the decrease in reliability over time so as to be great without setting the reliability so as to be low.

Further, when three or more AMRs 2 measure the reception intensity, regarding an AMR 2 which obtains the reception intensity of a radio wave with a statistically great deviation, the radio wave information determination unit 12 may set the information obtained by the AMR 2 such that the reliability is low at all times or may set the degree of the decrease in reliability according to overtime so as to be great.

When the reception intensity of a radio wave largely deviates from the reception intensities of radio waves measured in the surrounding area, the radio wave information determination unit 12 may not take in the reception intensity information of the radio wave. Alternatively, even when the radio wave information determination unit 12 takes in the reception intensity information of the radio wave, the radio wave information determination unit 12 may set the reliability so as to be low or may set the degree of the decrease in reliability over time so as to be great without setting the reliability so as to be low.

In this way, the radio wave information management device 10 of the third embodiment can determine the reception intensity information and reliability of radio waves with a higher accuracy in a case where a plurality of AMRs 2 could obtain the reception intensities of radio waves at the same spot.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radio wave information management system comprising:
an information stored unit configured to hold radio wave information, and location information and time information associated with the radio wave information;
a radio wave information determination unit configured to set reliability information for the radio wave information based on at least one of the location information and the time information; and
a route setting unit configured to set a route of a mobile object based on the reliability information.

2. The radio wave information management system of claim 1, wherein the radio wave information is obtained by one or more mobile objects.

3. The radio wave information management system of claim 1, further comprising a reception unit configured to receive the radio wave information.

4. The radio wave information management system of claim 1, wherein the radio wave information determination unit is configured to decrease a reliability of the radio wave information according to time elapsed based on the time information.

5. The radio wave information management system of claim 4, wherein the radio wave information determination unit is configured to make a degree of a decrease in the reliability of the radio wave information over time less regarding a location at which a plurality of radio wave information items are obtained based on the location information.

6. The radio wave information management system of claim 4, wherein:
the radio wave information includes radio wave information which is actually measured, and radio wave information which is estimated by using the measured radio wave information; and
the radio wave information determination unit is configured to make a degree of a decrease in the reliability of the radio wave information over time less regarding the measured radio wave information in comparison with the reliability information of the estimated radio wave information.

7. The radio wave information management system of claim 1, wherein:
the radio wave information is obtained by a plurality of mobile objects which receive radio waves from a base station; and
the radio wave information determination unit is configured to determine that, in a situation where a second mobile object intervenes between the base station and a first mobile object, radio wave information obtained by the first mobile object is not taken in based on the location information and the time information.

8. The radio wave information management system of claim 1, wherein:
the radio wave information is obtained by a plurality of mobile objects which receive radio waves from a base station; and
the radio wave information determination unit is configured to set, in a situation where a second mobile object intervenes between the base station and a first mobile object, a reliability of the radio wave information obtained by the first mobile object so as to be low based on the location information.

9. The radio wave information management system of claim 1, wherein the radio wave information determination unit is configured to determine that, regarding a location at which two or more radio wave information items with a difference less than or equal to a threshold are obtained within a predetermined time, one of values in a range from a maximum value to a minimum value in the two or more radio wave information items is taken in based on the location information and the time information.

10. The radio wave information management system of claim 9, wherein the value to be taken in in the range from the maximum value to the minimum value in the two or more radio wave information items is a mean value of the two or more radio wave information items.

11. The radio wave information management system of claim 1, wherein the radio wave information determination unit is configured to determine that, when a plurality of radio wave information items are obtained at a same location within a predetermined time, and when a difference in the radio wave information items is greater than a threshold, the radio wave information items are not taken in.

12. The radio wave information management system of claim 1, wherein:
the radio wave information is obtained by a plurality of mobile objects which receive radio waves from a base station; and
the radio wave information determination unit is configured to decrease, when three or more mobile objects obtain the radio wave information at a same location within a predetermined time, and the radio wave information obtained by two or more mobile objects of the three or more mobile objects is within a predetermined range, and the radio wave information obtained by the other mobile object or objects of the three or more mobile objects is outside the predetermined range, a reliability of the radio wave information obtained by the other mobile object or objects based on the location information and the time information.

13. The radio wave information management system of claim 1, wherein the radio wave information determination unit is configured to determine a minimum unit of the location information based on a wavelength of a radio wave used to obtain the radio wave information.

14. A radio wave information management method comprising:
holding radio wave information, and location information and time information associated with the radio wave information;
setting reliability information for the radio wave information based on at least one of the location information and the time information; and
setting a route of a mobile object based on the reliability information.

15. A non-transitory computer-readable storage medium having stored thereon a computer program which is executable by a computer, the computer program causing the computer to:
hold radio wave information, and location information and time information associated with the radio wave information;
set reliability information for the radio wave information based on at least one of the location information and the time information; and
set a route of a mobile object based on the reliability information.
